(19) United States
(12) Patent Application Publication
(10) Pub. No.: US 2006/0050953 A1
(43) Pub. Date: Mar. 9, 2006

(54) Pattern recognition method and apparatus for feature selection and object classification

(76) Inventors: Michael E. Farmer, Clarkston, MI (US); Shweta R. Bapna, Clarkston, MI (US)

Correspondence Address: Martin J. Jaquez, Esq.;JAQUEZ & ASSOCIATES, Suite 100D, 6265 Greenwich Drive, San Diego, CA, 92122, US

(21) Appl. No.: 11/157,466

(22) Filed: Jun. 20, 2005

Related U.S. Application Data
(60) Provisional application No. 60/581,158, filed on Jun. 18, 2004.

(51) Int. Cl. G06K 9/62; G06K 9/00

(52) U.S. Cl. 382/159; 382/104

(57) ABSTRACT

Methods and apparatus for processing features sampled and stored in a computing system are disclosed. Pattern recognition techniques are disclosed that facilitate decision making functions in computing systems, such as, for example, vehicle occupant safety systems and data mining applications. The disclosed correlation processing methods and apparatus improve the accuracy of data pattern recognition systems, including image processing systems.

### CROSS-REFERENCE TO RELATED APPLICATIONS AND CLAIM OF PRIORITY

This application claims the benefit of priority under 35 U.S.C. § 119 (e) to U.S. Provisional Application No. 60/581,158, filed Jun. 18, 2004, entitled “Pattern Recognition Method and Apparatus for Feature Selection and Object Classification.” (ATTY DOCKET NO. ETN-024-PROV). This application is related to co-pending and commonly assigned U.S. patent application Ser. No. ______, filed concurrently on Jun. 20, 2005, entitled “Vehicle Occupant Classification Method and Apparatus for Use in a Vision-based Sensing System” (ATTY DOCKET NO. ETN-023-PAP), which claims the benefit of priority under 35 U.S.C. § 119 (e) to U.S. Provisional Application No. 60/581,157, filed Jun. 18, 2004, entitled “Improved Vehicle Occupant Classification Method and Apparatus for Use in a Vision-based Sensing System” (ATTY DOCKET NO. ETN-023-PROV). This application is also related to pending and commonly assigned U.S. patent Ser. No. 10/944,482, filed Sep. 16, 2004, entitled “Motion-Based Segmentor Detecting Vehicle Occupants using Optical Flow Method to Remove Effects of Illumination” (ATTY DOCKET NO. ETN-029-CIP), which claims the benefit of priority under 35 USC § 120 to the following U.S. applications: “MOTION-BASED IMAGE SEGMENTOR FOR OCCUPANT TRACKING,” application Ser. No. 10/269,237, filed Oct. 11, 2002, pending; “MOTION BASED IMAGE SEGMENTOR FOR OCCUPANT TRACKING USING A HAUSDORF DISTANCE HEURISTIC,” application Ser. No. 10/269,357, filed Oct. 11, 2002, pending; “IMAGE SEGMENTATION SYSTEM AND METHOD,” application Ser. No. 10/023,787, filed Dec. 17, 2001, pending; and “IMAGE PROCESSING SYSTEM FOR DYNAMIC SUPPRESSION OF AIRBAGS USING MULTIPLE MODEL LIKELIHOODS TO INFER THREE DIMENSIONAL INFORMATION,” application Ser. No. 09/901,805, filed Jul. 10, 2001, pending. All of the U.S. provisional applications and non-provisional applications described above are hereby incorporated by reference herein, in their entirety, as if set forth in full.

### BACKGROUND

1. Field

The disclosed method and apparatus relates generally to the field of object classification systems, and more specifically to pattern recognition processing techniques used to enhance the accuracy of object classifications.

2. Related Art

In an object classification computer system, performance degradation occurs as more features or test samples related to an object are collected. Such performance degradation occurs partially because many of the collected features have varying degrees of correlation to one another. It becomes difficult for a computer object classification system to distinguish between object classes when objects are partially correlated to one another.

For example, in a vision-based object classification system, objects are represented by images and many image features are required to reliably represent the images. If the object classification set comprises a “child” and an “adult”, for example, then as more information is gathered about an observed object, the system attempts to converge on a decision as to which class the observed object belongs (i.e., “child” or “adult”). Exemplary applications include vision-based Automotive Occupant Sensing systems that selectively suppress or deploy an airbag in the event of a vehicle emergency. In such systems, the decision to deploy safety equipment is based in part on the classification of the vehicle occupant. Because small adults, for example, may have some features that are correlated with large children, it can be difficult for such systems to make accurate decisions regarding the classification of the observed vehicle occupant. This example demonstrates object classification issues present in virtually all pattern recognition systems that attempt to classify objects based upon image features.

One goal of pattern recognition systems is to fully exploit massive amounts of data by extracting all useful information from the data. However, when object data varies from very high correlation to very low correlation, relative to other objects in a data set, it becomes increasingly difficult to accurately distinguish between object classes.

In pattern recognition applications, such as “data mining” applications, extracted features must be correlated and relevant to the problem at hand. The extracted features should be insensitive to small variations in the data, and invariant to scaling, rotation, and translation. Additionally, the selection of discriminating features using appropriate dimension reduction techniques is needed.

The tools and techniques developed in the fields of data mining and pattern recognition are useful in many practical applications, including, inter alia, verification and validation processing, visualization processing, computational steering, remote sensing, medical imaging, genomics, climate modeling, astrophysics, and automotive safety systems.

The field of large-scale data mining is in its infancy, making it a growing source of research. In order to extend data mining techniques to large-scale data applications, several barriers must be overcome. The extraction of key features from large, multi-dimensional, complex data is a critical issue that must be addressed prior to the application of pattern recognition algorithms.

Additionally, cost is an important consideration for the effective implementation of pattern recognition systems, as described in U.S. Pat. No. 5,787,425, issued Jul. 28, 1998, to Bigus (hereinafter “the '425 patent”). As described in the '425 patent, since the beginning of the computer era, computer systems have evolved into extremely sophisticated devices, capable of storing and processing vast amounts of data. As the amount of data has increased, it has become increasingly difficult to interpret and understand the information implicit in the data. The term “data mining” refers to the concept of sifting through vast quantities of raw data in search of valuable “nuggets” of information. As noted in the '425 patent, each data mining application is typically developed from “scratch” (i.e., custom-designed), making it unique to each application. This makes the development process long and expensive. Thus, any method or apparatus that can reduce the costs inherent to data mining processing is valuable.

Thus, there is a need for a low-cost, high reliability pattern recognition system. The need exists for improved pattern recognition techniques amenable for use in applications such as data mining applications and vision-based sensing systems. The pattern recognition system should be robust and accurate, even in the presence of highly correlated object features. A method, apparatus, and article of manufacture that achieves these goals are set forth herein.

### SUMMARY

An improved pattern recognition system is described. The improved pattern recognition system processes feature information related to an object in order to filter and remove redundant feature information from the database. The disclosed pattern recognition system filters the redundant feature information by identifying correlations between features. Using the present techniques, object classifications can be determined with improved accuracy and confidence.

In one embodiment, vehicle occupant classification in a vision-based automotive occupant sensing system is vastly improved. Using the present pattern recognition system, an improved vision-based automotive occupant sensing system is implemented. The improved sensing system more accurately distinguishes between an adult and a child vehicle occupant, for example, based on visual images obtained by the system, in order to determine whether to deploy or suppress vehicle safety equipment, such as an airbag.

In one exemplary embodiment, the disclosed method and apparatus are implemented in a passenger vehicle safety system. The system obtains image information regarding vehicle occupants which is subsequently used by an occupant classification process. In one embodiment, the information is transferred to a memory storage device and analyzed utilizing a digital signal processor. Employing methods derived from the field of pattern recognition, a correlation processing method is implemented, wherein occupant feature information is extracted, filtered and either eliminated or saved in a memory for comparison to subsequently obtained information. Each feature is compared with every other feature, and evaluated for correlation. Highly correlated features are removed from further processing.

In another exemplary embodiment, the disclosed method and apparatus are implemented in a data mining process in order to extract useful information from a database. The exemplary data mining process employs large scale pattern recognition and selective removal of features using the present correlation processing techniques. In accordance with this embodiment, underlying distributions of ranked data sets are analyzed in order to extract redundant information from the data.

### BRIEF DESCRIPTION OF THE DRAWINGS

Embodiments of the disclosed method and apparatus will be more readily understood by reference to the following figures, in which like reference numbers and designations indicate like elements.

FIG. 1a is a process flow diagram illustrating an automated vehicle safety process adapted for use with the disclosed method and apparatus pattern recognition and feature selection techniques.

FIG. 1b(i) illustrates an image captured by a vision-based sensing peripheral.

FIG. 1b(ii) illustrates an exemplary segmented image of FIG. 1b(i).

FIG. 1c(i) illustrates a segmented image for a rear facing infant seat (“RFIS”).

FIG. 1c(ii) illustrates a segmented image for an adult.

FIG. 1c(iii) illustrates an edge image for an RFIS.

FIG. 1c(iv) illustrates an edge image for an adult.

FIG. 2a is a simplified flow chart illustrating a robust feature selection method.

FIG. 2b is an illustration of a k-nearest-neighbor query starting at test point x and illustrates spherical growth enclosing k training samples.

FIG. 2c illustrates a method of pruning out redundant test samples.

FIG. 2c(i) illustrates a two-class dataset of 200 samples per class of an original scatter plot.

FIG. 2c(ii) illustrates the scatter plot of FIG. 2c(i) after pruning by removing mis-classified samples.

FIG. 2d illustrates an upper row having segmentation errors and a bottom row having no segmentation errors.

FIG. 3 is a simplified flow chart of one embodiment of a feature correlation method that can be used in implementing the correlated feature removal step shown in FIG. 2a.

FIG. 4 is a histogram illustrating correlation coefficient values.

FIG. 5 is a binary correlation map for the top 25 features selected by a Mann-Whitney statistical processing, wherein black squares denote uncorrelated features.

FIG. 6a is a binary correlation matrix after step (4) of Table 1 has been completed, wherein black squares denote uncorrelated features.

FIG. 6b is a final N×N binary correlation matrix, wherein CMO(j,1)=0 and black squares denote uncorrelated features.

### DETAILED DESCRIPTION

Overview

Pattern recognition is fundamental to a vast and growing number of practical applications. One exemplary embodiment of the disclosed pattern recognition system set forth below is employed in an exemplary data mining method and apparatus. The skilled person will understand, however, that the principles and teachings set forth herein may apply to almost any type of pattern recognition system. Systems employing the new and useful pattern recognition methods include image analysis methods and apparatus, involving classification of a predetermined finite set of object classes. Such systems may include, for example, a vehicle safety system, wherein the pattern recognition methods and apparatus are implemented to accurately classify vehicle occupants and to determine whether or not to deploy a safety mechanism under certain vehicle conditions. In particular, a method or apparatus as described herein may be employed whenever it is desired to obtain the advantages of feature filtration and extraction.

The methods and apparatus described below accumulate information (i.e., features) related to an object, or set of objects, and analyze the information in order to identify, detect and eliminate redundant information. The methods described below may be implemented by software or firmware executed on a digital signal processor. As used herein, the term “digital processor” is meant generally to include any and all types of digital processing devices including, without limitation, digital signal processors (DSPs), reduced instruction set computers (RISC), general-purpose (CISC) processors, microprocessors, and application-specific integrated circuits (ASICs). Such processors may, for example, be contained on a single unitary IC die, or distributed across multiple components. Exemplary DSPs include, for example, the Motorola MSC-8101/8102 “DSP farms”, the Texas Instruments TMS320C6x, Lucent (Agere) DSP16000 series, or Analog Devices 21161 SHARC DSP.

As used herein, the term “safety equipment deployment scheme” is meant generally to include a method of classifying vehicle occupants, as described below, and selectively deploying (or suppressing the deployment of) vehicle safety equipment. For example, in one aspect of the disclosure, if a vehicle occupant is classified as a child, the safety equipment deployment scheme comprises suppressing deployment of an airbag during a vehicle crash.

As used herein, the terms “vision-based peripheral”, or “vision-based sensory device” is meant to include all types of optical image capturing devices including, without limitation, a single grayscale camera, monochrome video cameras, single monochrome digital CMOS camera with a wide field-of-view lens stereo cameras, and any type of optical image capturing device.

Automated safety systems are employed in a growing number of vehicles. Exemplary automated vehicle safety systems are described in the co-pending and commonly assigned U.S. patent application Ser. No. ______, filed concurrently with this application on Jun. 20, 2005, entitled “Vehicle Occupant Classification Method and Apparatus for Use in a Vision-based Sensing System” (ATTY DOCKET NO. ETN-023-PAP), which claims the benefit of priority under 35 U.S.C. § 119 (e) to U.S. Provisional Application No. 60/581,157, filed Jun. 18, 2004, entitled “Improved Vehicle Occupant Classification Method and Apparatus for Use in a Vision-based Sensing System” (ATTY DOCKET NO. ETN-023-PROV). As set forth above, both the utility application and corresponding provisional application No. 60/581,157 are incorporated by reference herein in their entirety for their teachings on automated vehicle safety systems. The exemplary safety systems set forth in the incorporated co-pending application can benefit from the methods set forth herein and may be readily combined and adapted for use with the present teachings by one of ordinary skill in the art.

Automated Vehicle Safety Method Using the Disclosed Feature Selection Techniques

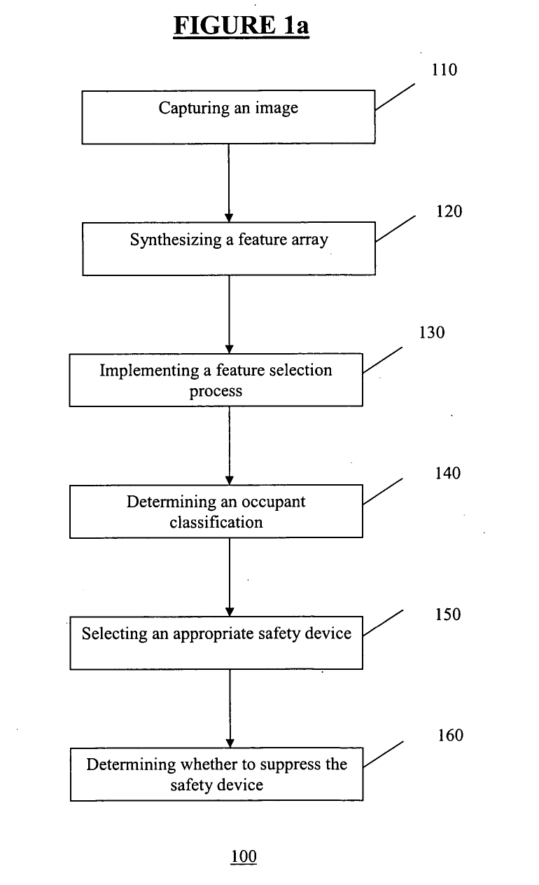

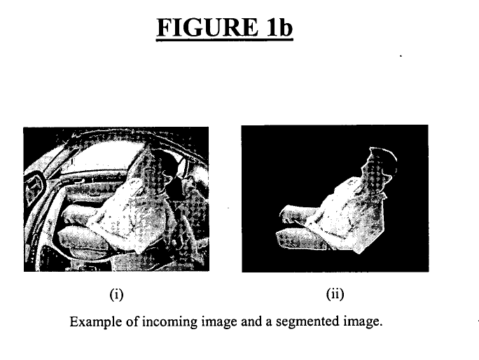

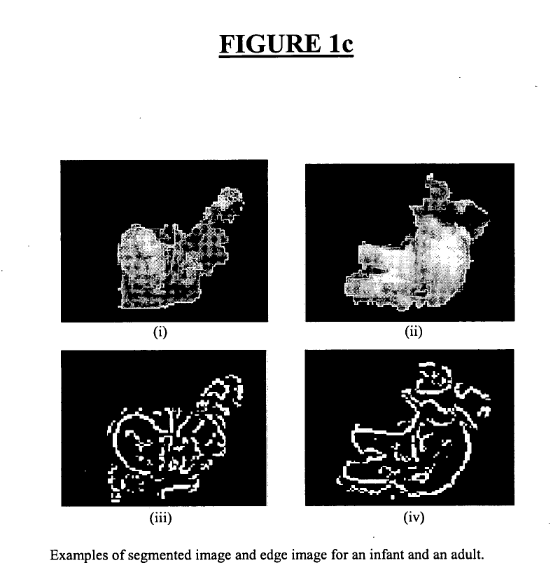

FIG. 1a shows a flow chart of an automated vehicle safety method 100, adapted for use with the disclosed pattern recognition and feature selection method of the present teachings. The vehicle safety method 100 may, for example, in one embodiment, be implemented using a digital signal processor, a memory storage, and a computing device, that are all components of an automated vehicle safety system. Features related to the physical characteristics of a vehicle occupant are sampled, stored and processed in order to accurately classify the occupant. In one embodiment, occupant classification is used for the purpose of selectively deploying safety equipment within the vehicle.

As shown in FIG. 1a, the method 100 begins at a first STEP 110 by capturing (i.e., sampling) an image of an environment within a vehicle. The STEP 110 is performed using a vision-based sensing peripheral, such as a camera. The peripheral operates to capture an image of the interior vehicle environment and occupants therein, and stores the image data in a local memory device.

After the image data is captured, the method 100 synthesizes a feature array, represented as a “feature vector”, in a predetermined memory storage area at a STEP 120. While there are many methods for synthesizing, or calculating features, in one exemplary embodiment, the disclosed method computes the mathematical moments of a segmented image. Referring now to FIG. 1b, a segmented image is an image where the occupant has been extracted from the background. FIG. 1b(i), for example, illustrates an image of a vehicle occupant having a background. FIG. 1b(ii) illustrates a segmented image, wherein the vehicle occupant has been removed from the background. There are numerous methods for accomplishing segmentation of an image, which are well known to those of ordinary skill in the art, and which are not described in more detail herein. According to one embodiment of the present disclosure, the STEP 120 (FIG. 1a) includes computing the edges of the image to reduce the effects of illumination. Reducing the effects of illumination is a technique that is well known in the art and therefore is not described in further detail herein.

According to one embodiment of the present disclosure, the STEP 120 of synthesizing a feature array includes techniques for reducing edge images from the segmented images in order to obtain a binary edge image. FIG. 1c illustrates an example of edge images computed from segmented images. FIG. 1c(i) illustrates a segmented image of a rear facing infant seat (RFIS) and FIG. 1c(iii) illustrates a corresponding binary edge image derived from the segmented image of the RFIS of FIG. 1c(i). Similarly, FIG. 1c(ii) illustrates a segmented image of an adult, and FIG. 1c(iv) illustrates a corresponding binary edge image derived from the segmented image of FIG. 1c(ii). The aforementioned edge images are referred to herein as “binary edge images”, because in these images the background is designated by the binary number ‘0’, and the edge itself by the binary number ‘1’.

In the described embodiment, once the image is reduced to a binary edge image, the image must be converted into a mathematical vector representation (an image originally is a 2-dimensional visual representation, and it is converted to create a 1-dimensional visual representation). A well-known method for analyzing edge images is to compute the mathematical “moments” of the image. The most well-known method of computing mathematical moments of an image employs computation of geometric moments of the image. The geometric moment of order “v” for an M×N image is defined as follows:

$${μ}_{mn} = {\sum }_{i = 1}^{M} {\sum }_{j = 1}^{N} I ( i , j ) \cdot {x ( i )}^{m} \cdot {y ( j )}^{n} ,$$

where x(i) ε [−1, 1] and y(j) ε [−1, 1], and where I(i,j) is the value of the image at pixel location row=i and column=j. These moments are typically computed for the value (m+n)≦45, creating 1081 moment values. In this particular embodiment, the created moments are then arranged into a vector form according to the following pseudo-code:

feature_vector = zeros(num_features, 1);

feature_count = 0;

for m=0:max_order_moments

for n=0:max_order_moments

if ( (m+n ≦ max_order_moments) &
(feature_count < num_features) )

feature_count = feature_count + 1;
feature_vector(feature_count) =
moments_array(m+1, n+1);

end

end

end

The above sub-method steps convert the collection of moments into a feature vector array. This process is performed on a collection of images (captured by a vision-based peripheral) and is referred to as a training set. In one embodiment, the training set consists of roughly 300-600 images of each type, and may comprise more than 1000 images of each type. According to one embodiment, if the process is implemented for a two-class occupant sensing (“infant” versus “adult”) these images are labeled with a ‘1’ if they are from class 1 (infant), and a ‘2’ if they are from class 2 (adult). This training set is used in the remaining processing method.

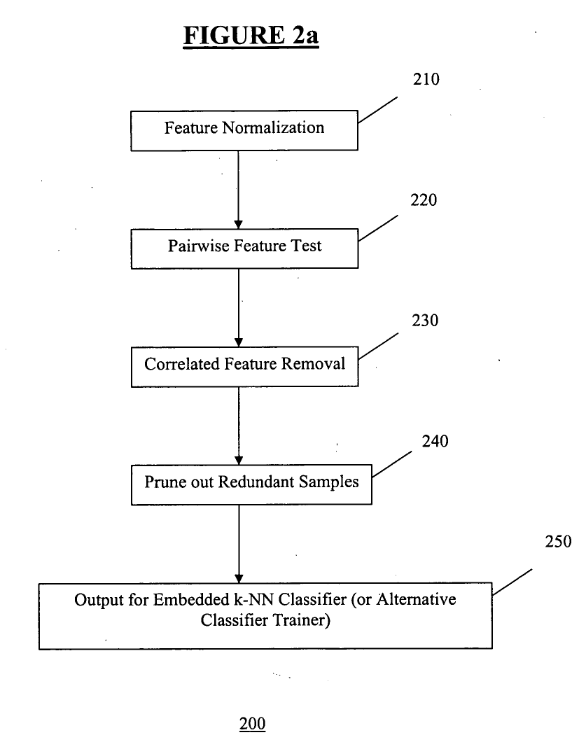

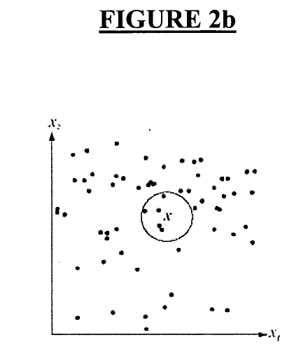

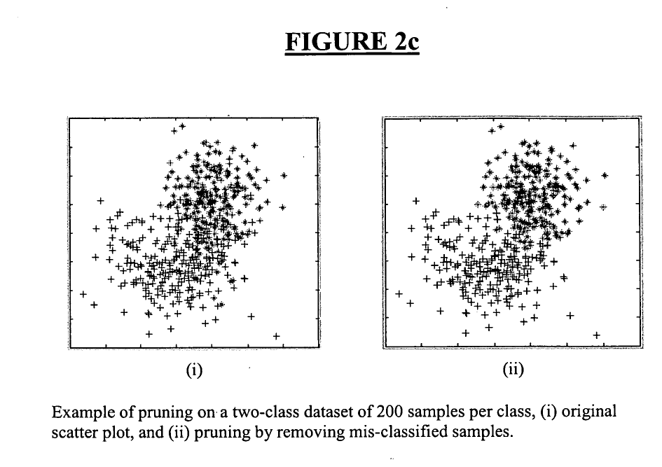

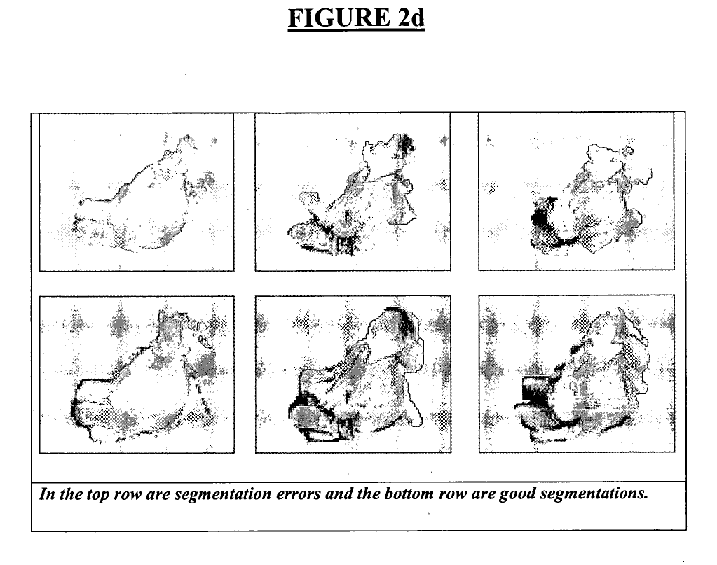

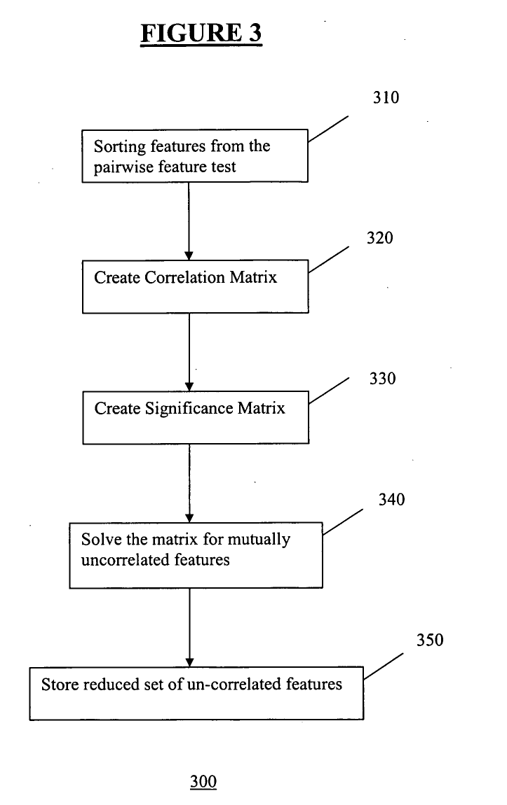

Referring again to FIG. 1, the method 100 then proceeds to an implementation of a feature selection process STEP 130. As described below in more detail with reference to FIG. 2a and FIG. 3, the feature selection processing STEP 130 includes the normalization and comparison of different feature vectors in order to determine if such vectors are from the same underlying distribution (i.e., occupant class). The feature selection processing STEP 130 also determines the statistical significance between the two vectors. More details related to feature selection processing is provided below with reference to FIGS. 2a and 3.

As shown in FIG. 1a, the method 100 then proceeds to a STEP 140 whereat the vehicle occupant image is classified based at least in part on the output of the feature selection processing STEP 130. In one embodiment, the occupant classification set comprises a finite set of predetermined potential passengers in a vehicle. For example, the occupant classification set may include an adult, a child, a Rear Facing Infant Seat (RFIS), and/or an empty class. The STEP 140 may, in one embodiment, be implemented employing methods described in the above-incorporated co-pending and commonly assigned U.S. application Ser. No. ______, filed concurrently with this application on Jun. 20, 2005, entitled “Vehicle Occupant Classification Method and Apparatus for Use in a Vision-based Sensing System” (ATTY DOCKET NO. ETN-023-PAP), and also described in U.S. Provisional Application No. 60/581,157, filed Jun. 18, 2004, entitled “Improved Vehicle Occupant Classification Method and Apparatus for Use in a Vision-based Sensing System” (ATTY DOCKET NO. ETN-023-PROV). More specifically, STEP 140 may, in one embodiment, be implemented using historical classification processing techniques disclosed in the above-incorporated co-pending application.

Referring again to FIG. 1a, the method 100 proceeds to a STEP 150 in order to select an appropriate safety device. A computing system using the method 100 determines which of the safety devices are available and appropriate for the circumstances, such as for example, and without limitation, an airbag, automatic windows, GPS equipment, and/or a buoy. This decision is partially based upon the type of vehicle being used (e.g., an automobile, watercraft, aircraft, spacecraft, etc.), and partially based upon available vehicle safety equipment. For example, if the circumstances involve an automobile crash, then the computing system might determine that airbags are appropriate. If, however, the vehicle is sinking in a body of water, the computing system might determine that a GPS signal should be sent and a buoy deployed. Under this scenario, the system may also automatically lower the vehicle windows in order to allow the passengers to swim from the vehicle, if appropriate. Implementation of a computer program required to execute the STEP 150 will be readily apparent to one of ordinary skill in the art, and is therefore not described further herein.

Referring again to FIG. 1a, the method 100 proceeds to a STEP 160 whereat the method 100 determines whether to suppress or deploy the safety device selected at the STEP 150. The decision as to whether to suppress or deploy the selected safety device is based, at least in part, on the occupant classification determined at the STEP 140. In one example, if the safety device selected in the STEP 150 is an airbag, and the occupant is classified as a child at the STEP 140, the method 100 will determine that suppression of the safety equipment (airbag) is appropriate at the STEP 160.

As described above, one use for the improved pattern recognition process is in data mining applications. Data mining refers to processes that uncover patterns, associations, anomalies, and statistically significant structures and events in data. One aspect of data mining processes is “pattern recognition”, namely, the discovery and characterization of patterns in image and other high-dimensional data. A “pattern” comprises an arrangement or an ordering in which some organization of underlying structure exists. Patterns in data are identified using measurable features, or attributes, that have been extracted from the data. In some embodiments, data mining processes are interactive and iterative, involving data pre-processing, search for patterns, knowledge evaluation, and the possible refinement of the processes.

In one embodiment, data may comprise image data obtained from observations or experiments, or mesh data obtained from computer simulations of complex phenomena, in two and three dimensions, involving several variables. The data is available in a raw form, with values at each pixel within an image, or each grid point in a mesh. As the patterns of interest are at a higher level, additional features should be extracted from the raw data prior to initiating pattern recognition techniques.

In one embodiment of the present disclosure, data sets range from moderate to massive, with some exemplary models being measured in Megabytes, Gigabytes, Terabytes. As more complex data collections are performed, the data is expected to grow to the Petabyte range and beyond.

Frequently, data is collected from various sources, using different sensors. In order to use all available data to enhance analysis, data fusion techniques are needed. This is a non-trivial task if the data is sampled at different resolutions, using different wavelengths, and under different conditions. Applications, such as remote sensing, may need data fusion techniques to mine the data collected by several different sensors, and at different resolutions. Data mining processes, for use in scientific applications, have different requirements than do their commercial counterparts. For example, in order to test or refute competing scientific theories, scientific data mining processes should have high accuracy and precision in prediction and description.

As described below in more detail, FIG. 2a illustrates an embodiment of a robust feature selection method 200 that is useful in data mining applications and automated vehicle safety systems. Data mining applications are useful in image data mining. If a user wanted to find all of the images of a selected person, the training set described above comprises an undetermined number of different people. The system computes the segmented image, edge image, and moments as described above in order to generate a feature vector of people in images. Next, the application selects the smaller set of features that best describe a person, and uses them to find all the images in a database that contain a person. One of ordinary skill will readily be able to implement the methods disclosed herein for such specific applications.

Alternate embodiments of the methods disclosed herein also include other areas of data mining such as, for example, non-image data. For example, a user may want to find all of the days that the stock market Dow Jones Industrial Average (DJIA) had an inverted ‘V’ shape for the day, which would signify the prices being low in the morning, high by mid-day, and low again by the end of the day. A stock trader can then estimate that the shape of the next day would be a true ‘V’, and then purchase stocks at mid-day to hit the low point in the prices. To test this hypothesis, the stock trader searches his past database for all days having an inverted ‘V’, and then looks at the results on the following day. For features, the stock trader uses an average DJIA value at 5-minute increments for the day, which yields 96 data points (8 hours×12 samples). This might be a feature vector that could be feature selected, since it may be that only certain times of day are the most important.

The feature selection method 200 of FIG. 2a may, in some embodiments, be adapted for use in improving object classification accuracy. The method 200 may be implemented, in one embodiment, using a digital signal processor, a memory storage device, and a computing device that are all components of an automated safety vehicle system.

Referring now to FIG. 2a, the feature selection method 200 includes steps for performing feature normalization 210, pairwise feature testing 220, removal of correlated features 230, pruning out of redundant samples 240, and outputting for an embedded k-NN classifier 250. Each of these steps is defined in more detail below with reference to FIG. 2a.

Feature Normalization

As shown in FIG. 2a, the robust feature selection method 200 begins with a feature normalization STEP 210. At the STEP 210, incoming feature vectors (i.e., feature arrays) are normalized. Exemplary normalization ranges include either a zero mean and variance of one, or optionally, a minimum of zero and maximum of one. Normalization of the incoming feature vectors reduces the deleterious effects that features having varying dynamic ranges may have on the object classification algorithm. For example, a single feature having a very large dynamic range can dwarf the relative distances of many other features and thereby detrimentally impact object classification performance. One example of where variations in feature vector dynamic ranges can detrimentally impact performance is in an automotive vision-based occupant sensing system, wherein geometric moments grow monotonically with the order of the moment and therefore can artificially give increasing importance to the higher order moments.

For example, as described above with reference to the geometric moments of an image, the terms in the equation are x(i)^{m} and y(j)ⁿ, which are exponential terms in the pixel locations x and y. The higher the value of m and n (i.e. the bigger the moment order) the larger the term will be. It is better to scale these values. In this embodiment, for each incoming feature, a mean and variance are computed and removed from all of the training samples. In one embodiment, computing the mean and variance for normalization proceeds according to the following pseudo-code:

for i=1:num_features

feature_sum = sum(training_set(1:num_training_samples,i));
feature_sum_sqr =
sum(training_set(1:num_training_samples,i).\hat{ }2);

feature_sum = feature_sum/num_training_samples;

feature_sum_sqr = feature_sum_sqr/num_training_samples;

feature_var = feature_sum_sqr − feature_sum\hat{ }2;

feature_scales(i, 1) = feature_sum;
feature_scales(i, 2) = sqrt(feature_var);

end

More specifically, in one embodiment, the method 200 employs the above described normalization range of zero mean, having a variance of one, wherein for each feature vector, a mean and variance are computed and removed from all of the training samples. In one embodiment, the actual mean and variance removal is performed in accordance with the following pseudo-code:

for i=1:num_features

training_set(1:num_training_samples,i)=

(training_set(1:num_training_samples,i) −
feature_scales(i, 1))/feature_scales(i, 2);
End

The mean and variance are also stored in memory for removal from incoming test samples in the embedded system (for example, in one embodiment, the system in a vehicle that performs occupant sensing functions, rather than the training system which is used to generate the training feature vectors and the feature_scales vector). The mean and variance are stored in memory in the vector feature_scales described above. In one embodiment, the above mentioned normalization range from minimum (Min=0) to the maximum (Max=1) is employed. In this embodiment, for each feature, the minimum values are subtracted from all of the other samples, after which the samples are normalized by the (Max-Min) of the feature. As with the mean-variance normalization method, these values are stored for removal from the incoming test samples in the embedded system. In one embodiment, the test samples comprise samples that are generated by the embedded system within a vehicle as the vehicle is driven with an occupant in the vehicle. In one embodiment, the test samples are calculated by having a camera in the vehicle collect images of the occupant, then the segmentation, edge calculation, and feature calculations are all performed as defined herein. This resultant feature vector comprises the test sample. The training samples comprise the example samples described above.

Pair-Wise Feature Test

Referring again to FIG. 2a, the method 200 then proceeds to a Pair-wise Feature Test STEP 220. At the Pair-wise Feature Test STEP 220, the features normalized in the STEP 210 are tested. In one embodiment, a well known “Mann-Whitney” test is implemented for each feature and is used to infer whether samples are derived from a same sample distribution or from two different sample distributions. The Mann-Whitney test is a non-parametric test used to compare two independent groups of sampled data. The textbook R. J. Larsen and M. L. Marx, An Introduction to Mathematical Statistics and its Applications, Prentice-Hill, 1986 provides a more detailed description of the Mann-Whitney method, and is hereby incorporated by reference herein for its teachings in this regard.

In one embodiment, the mechanics of the Mann-Whitney test are as follows. All of the class labels are removed, and the patterns are ranked from the smallest to the largest for each feature. The labels are then re-associated with the data values, and the sum of the ranks is computed for each of the two classes, labeled A and B. The sum of these ranks is then compared to the sum of the ranks that would be expected if the two data sets were from the same underlying distribution. This expected rank sum, and the corresponding variance, is computed in accordance with the following mathematical equation:

$${μ}_{A} = \frac{{n}_{A} ( N + 1 )}{2} , and$$

$${σ}_{AB} = \frac{{n}_{A} {n}_{B} ( N + 1 )}{12} .$$

where n_{A} and n_{B} comprise the number of samples from each of the two classes A and B, respectively. The value μ_{A} is then compared with the actual sum of the ranks for label A, namely S_{A}. A z-ratio test is used because the underlying distribution of the rank data is normal, based on the weak law of large numbers:

$$z = \frac{( {S}_{A} - {μ}_{A} ) \pm 0.5}{{σ}_{AB}}$$

In one embodiment of the Pair-Wise Feature Test STEP 220, each feature is processed sequentially, where all of the training samples for the first feature in the feature vector are used to calculate the means and variances for the Mann-Whitney, and then the second feature in the feature vector is used, and then the next feature vector, and so forth iteratively, until all of the features in the feature vector have been processed. For each feature, all of the samples that correspond to class 1 and class 2 are extracted and stored in a vector, where above class 1 is the first pattern type (for example, in the airbag application it might be an infant), and class 2 is the second pattern type (for example, in the airbag application example it might be an adult). The stored vectors are then sorted, and ranks of each value are then recorded in a memory storage location. The sums of the ranks for each classification are then computed, as described above. A null hypothesis set of statistics are also computed at the STEP 220.

A null hypothesis is the hypothesis that all of the training samples from both classes appear to derive from the same distribution. If the data for a given feature appears to derive from the same distribution then it is concluded that the given feature cannot be used to distinguish the two classes. If the null hypothesis is false, then it means that the data for that feature does appear to come from two different classes of data. In this case, the feature can be used to distinguish the classes. In one embodiment, the null hypothesis set is computed according to the following pseudo-code:
null_hyp_mean=num_class*(num_class+num_else+1)/2; and
null_hyp_sigma=sqrt(num_class*num_else*(num_class+num_else+1)/12

In one embodiment of the Pairwise Feature Test STEP 220, a statistic is then computed according to the following equation

$$z = \frac{( {S}_{A} - {μ}_{A} ) \pm 0.5}{{σ}_{AB}} .$$

At least four possible sub-methods may then be used at this juncture. Each of the at least four sub-methods have varying effects in different applications as described below.

SUB-METHOD 1: In this sub-method, the Mann-Whitney test values are thresholded, and any features whose pair-wise separability exceeds this threshold are retained. Pair-wise separability refers to how different the two distributions of the samples appear. This is useful if all of the classes are roughly equally separable, which is the case when all of the features in the feature vector have roughly the same pair-wise separability. This sub-method is also useful because the threshold can be chosen directly from a confidence in the decision. The confidence in the fact that the null-hypothesis is false (as described above, this means that the training samples appear to be from two different distributions). The value ‘z’, computed earlier, is a “Student-t test” variable, which is a standard test in the statistics literature as noted above in the Marx reference. In general, “confidence” refers to the certainty that the null hypothesis is not true. For example, for a confidence of 0.001, the threshold is 3.291 according to the standard Statistics literature (for more details regarding these statistical techniques, see the Marx book referenced above).

SUB-METHOD 2: A second sub-method of the STEP 220 finds the top N-features with the best pair-wise separability for each class. This sub-method is well-suited in situations where one class is far less separable from another, as is the case when distinguishing between small adults and large children in a vision based vehicle occupant example. In this sub-method, the final number of features is exactly known to be (N* number of classes). For example, as described above, a system may have 1081 features without feature selection. If only 100 or so features are desired, set N=50, and a 2-class problem results, and 100 features remain. In this processing, the features are sorted based on their ‘z’ value, and the top 100 features (the features with the largest ‘z’ values are kept because these features) have the most separability.

The ‘z’ value is computed according to the following equation:

$$z = \frac{( {S}_{A} - {μ}_{A} ) \pm 0.5}{{σ}_{AB}}$$

SUB-METHOD 3: In a third sub-method of the Pairwise Feature Test STEP 220, a combined statistic is computed for each feature as the sum(abs(statistic for all class pair combinations)). This method is used if there are more than 2 possible pattern classes, for example, if it is desired to classify infants, children, adults, and empty seats, rather than simply infants and adults as in a 2-class application. In this case, the ‘z’ statistic is calculated pairwise for all combinations (i.e. infant-child, infant-adult, child-adult, infant-empty, child-empty, and adult-empty). The next step is to sum together the ‘z’ value for all of these pairs. This sub-method provides a combined separability, which is the ability of any feature to provide the best separability for all of the above pairs of tests. Other options, such as a weighted sum, are also possible, wherein the weighting may depend on the importance of each class. For example, if the most important pair is the infant-adult pair, then in the sum(abs( )) term would have: wt_1* z-infant-adult+wt_2*z-child-adult+wt_3*z-infant-child+wt_4*z-infant-empty+wt_5*z-adult-empty+wt_6*z-child-empty), wherein wt_1 is greater than the other weights, and wt_1+wt_2+wt_3+wt_4+wt_5+wt_6=1. As with sub-method 2, sub-method 3 provides a fixed number of output features.

SUB-METHOD 4: In a fourth sub-method of the Pairwise Feature Test STEP 220, all of the incoming features are sorted into an order of decreasing absolute value of the Mann-Whitney statistic without any reduction in the number of features. This sub-method produces more features to test, however, it is useful in preserving additional feature values if there is a possibility that a large number of the features may be correlated, and hence removed as described in more detail below. In this method, the ‘z’ (as described above) value for each feature in the feature vector is taken and the indices of the feature vector are sorted using the ‘z’ value for ranking. Thus the first feature in the vector is now the one with the largest ‘z’ value, the second feature has the second largest ‘z’ value and so forth, until all ‘z’ values have been ranked.

In some applications, for example, in vehicle occupant sensing systems, the second, third and fourth sub-methods, described above, work best, as they provide the least number of features.

Correlated Feature Removal

Referring again to FIG. 2a, the robust feature selection method 200 proceeds to a STEP 230, whereat correlated features are removed. Many of the features that have been retained until this point in the method may have relatively high cross correlation. High correlations between two features indicate that the features provide similar or redundant information. Such highly correlated features increase confidence in a decision despite the fact that no real additional information is provided. For example, in one embodiment, if multiple features indicate that the shoulders of a vehicle occupant are consistent with that of an adult, additional incoming features relating to the shoulders provide redundant information that increases the confidence that the observed occupant is an adult. However, the additional features provide no useful additional information. To remove the redundant feature information, a correlation coefficient is computed between every pair of features for all of the incoming test samples. This value is computed according to the following equation:
Correl_coeff(A,B)=Cov(A,B)/sqrt(Var(A)*Var(B));

Wherein Cov(A,B) comprises the covariance of feature A with feature B; and Var(A) comprises the variance of feature A, and Var(B) comprises the variance of feature B over all of the training samples. In some implementations, these values are tested to a pre-defined threshold, and feature B is discarded if it is too highly correlated with feature A. This simple threshold, however, does not work well in cases where there are not a large number of training samples. In this case, the significance of the correlation coefficient must also be computed. In some embodiments, the number of training samples may be considered as not being large when it is on the order of a few hundred to one thousand samples per class. In one embodiment, for this case, the Fisher Z-transform should be computed in order to test the significance of the correlation. The Fisher Z-transform is defined as follows:
½ln((1+r)/(1−r)+1.96*sqrt(1/(n−3))=½ln((1+p)/(1−p));
where “r” is the computed correlation coefficient, and wherein “p” is the unknown true correlation. This equation may then be solved for two values of “p”, “p_low” and “p_high”. If the signs of these two values are identical (i.e. they lie on the same side of zero) then the data is considered to be statistically significant. It is useful to determine if the correlation is statistically significant, because in real-world data, all values are correlated by some amount, although in some applications, that amount may be relatively small. For example, in census data, there may be a correlation between zip codes and residents' favorite color of shoes, but this is clearly less significant than a correlation between zip codes and median income. One goal is to determine the truly correlated features and not the features, that may have only a very modest correlation, or that are statistically insignificant.

In one exemplary embodiment, correlation processing is performed during the correlated feature removal of STEP 230. Although the exemplary correlation processing is described in substantially greater detail below with reference to FIG. 3, a brief overview of correlation processing is briefly described.

In brief, the method of correlation processing includes the steps of i.) creating a correlation matrix, ii.) creating a significance matrix, and iii.) solving the correlation matrix for mutually uncorrelated features. The specific details of the disclosed correlation process are described below in more detail with reference to FIG. 3.

Pruning Out of Redundant Samples Based on Misclassifications

Referring again to FIG. 2a, the method 200 proceeds to a STEP 240 whereat redundant samples are pruned out of an accumulated sample set. When training samples are collected, considerable redundancy in the sample space often exists. In other words, multiple samples often provide very similar information. For example, in one embodiment, a number of exemplary training samples might be collected from a sample set of vehicle occupants of similar size and wearing similar clothing styles. In order to prune out redundant samples, the disclosed method and apparatus performs a “k-Nearest Neighbor” classification on every training sample against the rest of the training samples. This method begins by individually examining each training sample. Initially, each training sample is treated as an incoming test sample, and classified against a training dataset. A k-nearest neighbor classifier is then used, which classifies a test sample x by assigning it the class label most frequently represented among the K nearest samples of x, as shown in FIG. 2b. FIG. 2b is an illustration from the text entitled “Pattern Classification” by Richard O. Duda, Peter E. Hart, and David Stork, copyright 2001. This text is incorporated herein by reference for its teaching on pattern classification. FIG. 2b illustrates the “k-nearest-neighbor” query, which starts at the test point “x” and grows in a spherical region until it encloses k training samples. The query then labels the test point by a majority vote of these samples. In this particular illustration, k=5, and the test point “x” is labeled with the category of the black points.

In one embodiment, assuming that a “k-Nearest Neighbor” (k-NN) classifier is used, the order for “k” that is used should be the same value of the k-value used by the end system. In the vehicle occupant classification embodiment of the present teachings, because there is so much variability in clothing worn by occupants, it is nearly impossible to sensibly parameterize all clothing. Therefore, in one exemplary embodiment, a k-NN classifier is used. For this method, the disclosed system tests the classification of every sample against all of the remaining samples. If the classification of a sample is “incorrect”, the sample is discarded. A classification of a sample is incorrect if it is from class 1, but all of its k-nearest neighbors are from class 2. If such is the case, then the classifier method proceeds assuming the sample should be from class 2.

FIG. 2c illustrates one example of implementing pruning on a two-class dataset of 200 samples per class. FIG. 2c(i) shows an original scatter plot of samples. FIG. 2c(ii) shows the same plot of FIG. 2c(ii) having mis-classified samples removed by pruning.

This approach is superior to other techniques for discarding samples that are perfectly classified, as other techniques tend to keep samples that may, in fact, be poor representations due to earlier processing errors, such as, for example, those caused by segmentation errors. One example of a segmentation error is when an image of a head of an adult vehicle occupant is partially missing and subsequently appears as the head of a child. Such examples of “good” and “bad” segmentations are shown in FIG. 2d, wherein the upper row of FIG. 2d show examples of “bad” segmentations, and the bottom row show examples of “good” segmentations.

Output for an Embedded k-NN Classifier Trainer or Alternative Classifier Training

Referring again to FIG. 2a, the method 200 then proceeds to a STEP 250 whereat the samples are converted to a data format that is compatible with an embedded processor. The data format is dependent on the type of embedded processor used. For example, in one embodiment, if a processor is fixed point, the skilled person appreciates that the data should also be fixed point. If the data is floating point, then the floating point format must match in terms of exponent and mantissa. In this STEP 250, the samples may optionally be compressed using a lossless compression scheme in order to fit all of the samples into a defined memory space. It is also possible to use this reduced training set to train another type of classifier such as, for example, a Support Vector Machine. The method for training each type of classifier differs from application to application. Those skilled in the art shall understand how to take a specific set of training vectors and train their particular classifier.

Correlation Processing

FIG. 3 is a simplified flowchart showing a correlation processing method 300 that may be used, at least in part, when implementing STEP 230 of the method 200 (FIG. 2a). The correlation processing method 300 may also be implemented in a stand alone application. The robustness of the pattern recognition processing is improved when correlation processing is performed, because each feature in the feature vector provides unique information. Two features that are correlated provide a partial amount of duplicate information. This means that only one of the two features is needed, and it is therefore better to add another feature that is not correlated in order to provide new information to the classification task.

The correlation processing method 300 begins with sorting features from a pairwise feature test at a STEP 310. In one embodiment, at the STEP 310, features obtained from the pairwise feature test (as described above with reference to the STEP 220, FIG. 2a). In this embodiment, N features are sorted in descending order according to the Mann-Whitney Statistic:

$$z = \frac{( {S}_{A} - {μ}_{A} ) \pm 0.5}{{σ}_{AB}} .$$

As descried above, when sorting, the feature with the highest Mann-Whitney score (the ‘z’ score) is placed at the top of the list of features, and then the feature with the second highest, and so forth, until all of the features in the feature vector are arranged in this descending order of Mann-Whitney ‘z’ values.

Referring again to FIG. 3, the method proceeds to a STEP 320, whereat a correlation matrix is created. In one embodiment, an N×N correlation matrix is created using the correlation formula described above with reference to the STEP 230 of the method 200, namely:
Correl_coeff(A,B)=Cov(A,B)/sqrt(Var(A)*Var(B)).

In this equation, A is representative of one feature, B is representative of another feature. Cov(A,B) is the covariance between the two calculated in the standard manner (see the Marx reference). Var(A) and Var(B) are the variances for the features A and B. An array is generated which comprises a square matrix where every entry is a value Correl_coeff(A,B), wherein the feature index for A is the row value of the location of value Correl_coeff(A,B), and wherein the feature index for B is the column value of the location of value. A more detailed description of the implementation of this equation is provided in the Marx reference incorporated above.

The method 300 then proceeds to a STEP 330, whereat another N×N matrix is created. This matrix is defined as a binary feature significance matrix.

The method 300 then proceeds to a STEP 340 whereat the matrix is solved for mutually uncorrelated features. In one embodiment, in this step of the correlation processing, the results of non-parametric statistics are used, and the “Spearman-R” correlation coefficient is computed between all of the features over the training dataset. This value is computed in a manner that is similar to the traditional correlation coefficient, where the actual values are replaced by their ranks. While no assumptions can be made regarding the distributions of the data values, the ranks of the values can be assumed to be Gaussian. The first step in the Spearman-R statistic calculation is to individually rank the values of each feature. The Spearman-R correlation coefficient is defined identically to the traditional correlation coefficient, as follows:

$$ρ ( A , B ) = \frac{Cov ( A , B ) )}{\sqrt{{σ}^{2} ( A ) \cdot {σ}^{2} ( B )}}$$

Cov(A, B) comprises the covariance of ranks of feature A with respect to the ranks of feature B, and δ² (A) is the variance of ranks of feature A over all of the training samples.

Given N features, this generates an N×N correlation coefficient matrix, which can then be threshold based on the statistical significance of these correlation values. In one embodiment, the Student-t test (described above) may now be used, because, as described above, the underlying distributions of the ranks are Gaussian.

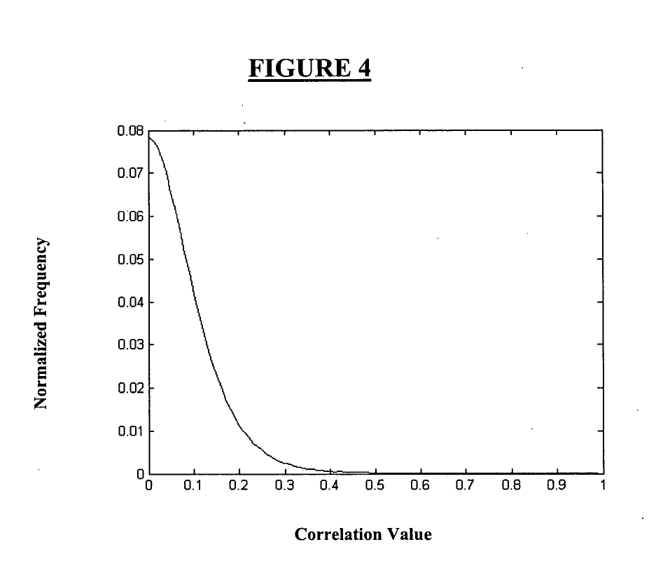

As shown in FIG. 4, in most “real-world” data sets, there is often some level of correlation between all of the features. This is shown in the histogram of FIG. 4, which shows a histogram of correlation coefficient values from zero to one. FIG. 4 illustrates a typical histogram of correlation coefficient values for a 1081 element Legendre moments feature vector. In FIG. 4, the horizontal axis comprises the correlation value, and the vertical axis comprises the frequency of occurrence for each of those values in the dataset. Therefore, deciding if features are correlated is not a simple binary decision, but rather a decision based on the level of significance of the correlation the system is willing to accept in the final feature set. It is this fact that limits the ability of wrapper methods to ensure that final features are not correlated, except in artificially constructed data sets.

The correlation significance test takes the following form:

$$\vert \sqrt{( n - 2 )} \cdot \frac{ρ ( X , Y )}{\sqrt{1 - {ρ ( X , Y )}^{2}}} \vert \geq {t}_{n - 2}$$

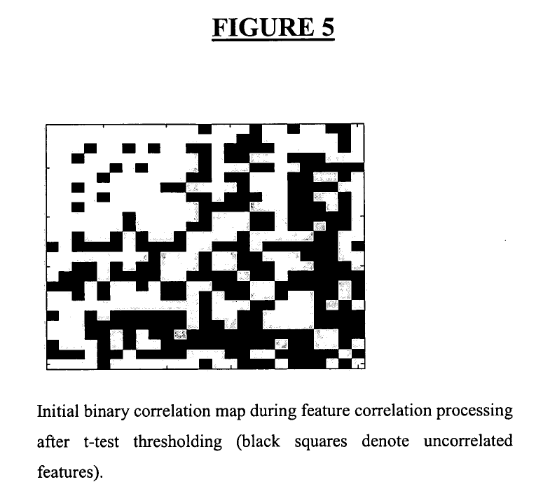

Note that the expression tₙ₋₂ comprises the Student-t test of degree n-2, and that n comprises the number of training samples. This thresholding process creates an N×N binary feature significance matrix where, a 1 (white) indicates a correlated feature, and a 0 (black) indicates an uncorrelated feature. Referring now to FIG. 5, one embodiment of the feature significance matrix is illustrated as a binary matrix (as shown). Note that all of the diagonal elements are 1 (white), because each feature is correlated with itself. In one exemplary embodiment, an algorithm for the feature correlation analysis is defined as shown in Table 1 below.

TABLE 1
Definition of an exemplary algorithm for correlation
post-processing for feature selection.

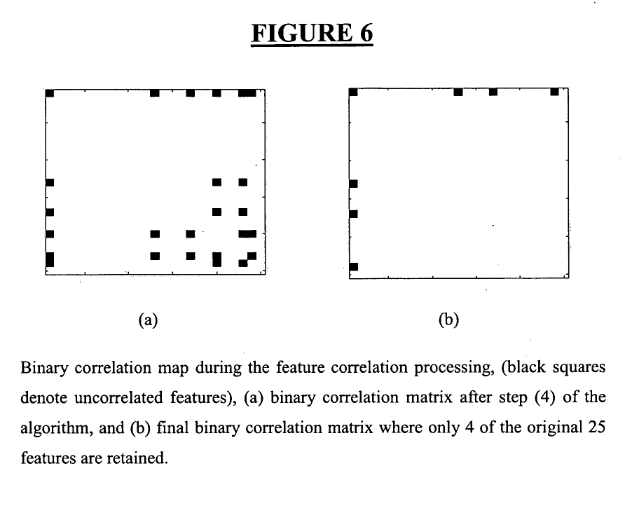

1. Create the N × N correlation coefficient matrix, CM(-, -).
2. Threshold CM based on the t-test of the coefficients to create
a binary version of CM as shown in FIG. 6 (a).
3. Retain the first feature since it has the best discrimination
(i.e., make CM(1, 1) = 0 (black) or uncorrelated).
4. For every row in the first column, make row j and column j all
ones (white) if CM(j, 1) = 1 (white). This creates the matrix
shown in FIG. 6 (b).
5. For every row in the first column where CM(j, 1) = 0 (black),
test all i > j if any CM(i, 1) = 0, it implies feature i is
correlated with feature j. Make the row and the column for feature
i all ones (white).
6. Repeat step 5 for all the features remaining in the matrix.

In this embodiment, the intermediate N×N correlation matrix, CM, defined in step 1 shown in Table 1, is shown in FIG. 6(a). The final N×N correlation matrix, CM, is shown in FIG. 6(b). All CM(j,1)=0 (black) signify that the feature is a member of the final feature set. These features comprise the subset of mutually uncorrelated features with the best available discriminating ability.

Referring again to FIG. 3, the method 300 then proceeds to a STEP 350 whereat the complete set of uncorrelated features in the uncorrelated features array is stored in memory storage device for further processing.

The disclosed correlation processing methods and apparatus may be incorporated into a data mining system for large, complex data sets. The system can be used to uncover patterns, associations, anomalies and other statistically significant structures in data. The system has an enormous number of potential applications. For example, it has applications that may include, but are not limited to, vehicle occupant safety systems, astrophysics, credit card fraud detection systems, nonproliferation and arms control, climate modeling, the human genome effort, computer network intrusion detection, and many others.

Conclusion

The foregoing description illustrates exemplary implementations, and novel features, of aspects of a method and apparatus for effectively providing a correlation processing system that improves pattern recognition algorithms, such as, for example, data mining and vehicle safety systems. Given the wide scope of potential applications, and the flexibility inherent in digital design, it is impractical to list all alternative implementations of the method and apparatus. Therefore, the scope of the presented disclosure should be determined only by reference to the appended claims, and is not limited by features illustrated or described herein except insofar as such limitation is recited in an appended claim.

While the above description has pointed out novel features of the present teachings as applied to various embodiments, the skilled person will understand that various omissions, substitutions, permutations, and changes in the form and details of the methods and apparatus illustrated may be made without departing from the scope of the disclosure. For example, occupants of a vehicle may have many meanings, including subsets other than human, such as for example, animals or inert entities. The exemplary embodiments describe an automobile having human occupants, but other types of vehicles having other types of occupants also fall within the scope of the disclosed concepts. These and other variations in vehicles or occupants constitute embodiments of the described methods and apparatus.

Although not required, the present disclosure is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the present teachings may be practiced with other computer system configurations, including hand-held devices, multiprocessor systems, microprocessor-based or programmable consumer electronics, network PC's, minicomputers, mainframe computers, and the like. The disclosure may also be practiced in distributed computing environments where tasks are performed by remote processing devices that are linked through a communications network. In a distributed computing environment, program modules may be located in both local and remote memory storage devices.

The computer may operate in a networked environment using logical connections to one or more remote computers. These logical connections are achieved by a communication device coupled to or a part of the computer; the present disclosure is not limited to a particular type of communications device. The remote computer may be another computer, a server, a router, a network PC, a client, a peer device or other common network node, and typically includes many or all of the elements described above relative to the computer. The logical connections include a local-area network (LAN) and a wide-area network (WAN). Such networking environments are commonplace in office networks, enterprise-wide computer networks, intranets and the Internet, which are all types of networks.

Each practical and novel combination of the elements and alternatives described hereinabove, and each practical combination of equivalents to such elements, is contemplated as an embodiment of the present disclosure. Because many more element combinations are contemplated as embodiments of the disclosure than can reasonably be explicitly enumerated herein, the scope of the disclosure is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art.

What is claimed is:

1. A feature selection method for use in a data processing system, wherein the data processing system samples data containing a plurality of features associated with the data, and wherein the data processing system maintains an initial training data set, and wherein the initial training data set includes a plurality of features associated with the initial training data, comprising:
(a) sampling the data to derive at least one feature associated with the sampled data;
(b) synthesizing a feature vector from the at least one feature derived during step (a), wherein the feature vector includes one or more features associated with the data sampled at step (a);
(c) normalizing the feature vector synthesized at step (b), thereby creating a normalized feature vector;
(d) performing a non-parametric pair-wise feature test upon the normalized feature vector, wherein adjacent elements in the normalized feature vector are compared in a pair-wise manner thereby generating a plurality of tested features, wherein the tested features represent statistical relationships between the adjacent elements of the normalized feature vector;
(e) performing correlation processing upon the normalized feature vector, wherein the correlation processing includes:
(1) sorting the tested features generated in step (d);
(2) organizing the sorted tested features into a correlation matrix; and
(3) creating a correlation coefficient matrix corresponding and associated to the correlation matrix, wherein the correlation coefficient matrix includes information indicative of correlation between the tested features; and
(f) removing a selected feature from a training set if the selected feature is determined to be highly correlated to one or more other features in the training set based on the correlation processing performed in step (e).

2. The feature selection method of claim 1, wherein the sampled data comprises a plurality of images, and wherein the synthesizing step (b) further comprises creating a segmented image from a selected one of the plurality of images, and computing at least one mathematical moment of the segmented image.

3. The feature selection method of claim 2, further comprising computing at least one edge image from the segmented image.

4. The method of claim 3, wherein the at least one edge image is computed using geometric moments of the at least one edge image, wherein the geometric moments are computed in accordance with the following mathematical expression:
$${μ}_{mn} = {\sum }_{i = 1}^{M} {\sum }_{j = 1}^{N} I ( i , j ) \cdot {x ( i )}^{m} \cdot {y ( j )}^{n} .$$

5. The method of claim 1, wherein the step (e)(1) of sorting the tested features further comprises ranking the tested features in descending order of Mann-Whitney z values.

6. The method of claim 5, wherein the Mann-Whitney z values are compared to a threshold, and wherein the Mann-Whitney z values exceeding the threshold are retained for further analysis.

7. The method of claim 1, wherein the step (e)(1) of sorting further comprises determining at least one feature that has a best pair-wise feature separability.

8. The method of claim 1, wherein the step (e)(1) of sorting further comprises computing a combined statistic for each of the tested features.

9. The method of claim 1, wherein the correlation coefficient matrix is computed in accordance with the following mathematical expression:
Correl_coeff(A,B)=Cov(A,B)/sqrt(Var(A)*Var(B)), wherein A and B comprise adjacent elements of the normalized vector.

10. A method of classifying an occupant of a vehicle interior into one of a plurality of occupant classifications, wherein images of the vehicle interior are captured by an imaging device, comprising:
(a) obtaining at least one image of the vehicle interior;
(b) synthesizing at least two feature arrays based upon the at least one image obtained during step (a);
(c) processing the at least two feature arrays synthesized in step (b) in accordance with a feature selection process, wherein the feature selection process normalizes the feature arrays and compares the at least two arrays to determine a significance of correlation between the arrays; and
(d) classifying the vehicle occupant as one of the plurality of occupant classifications.

11. The method of claim 10, wherein the synthesizing step further comprises computing at least one mathematical moment of a selected image, wherein the selected image is further processed and converted into a segmented image.

12. The method of claim 11, further comprising computing at least one edge image from the segmented image.

13. The method of claim 12, wherein the at least one edge image is computed using geometric moments of the segmented image, in accordance with the following mathematical expression:
$${μ}_{mn} = {\sum }_{i = 1}^{M} {\sum }_{j = 1}^{N} I ( i , j ) \cdot {x ( i )}^{m} \cdot {y ( j )}^{n} .$$

14. A data processing system, wherein the data processing system samples data containing a plurality of features associated with the data, and wherein the data processing system maintains an initial training data set, and wherein the initial training data set includes a plurality of features associated with the initial training data, comprising:
(a) means for sampling the data to derive at least one feature associated with the sampled data;
(b) means, responsive to the sampling means, for synthesizing a feature vector from the at least one feature derived by the sampling means, wherein the feature vector includes one or more features associated with the sampled data;
(c) means, responsive to the synthesizing means, for normalizing the synthesized feature vector, thereby creating a normalized feature vector;
(d) means, coupled to the normalizing means, for performing a non-parametric pair-wise feature test upon the normalized feature vector, wherein adjacent elements in the normalized feature vector are compared in a pair-wise manner thereby generating a plurality of tested features, and wherein the tested features represent statistical relationships between the adjacent elements of the normalized feature vector;
(e) means, coupled to the non-parametric pair-wise feature test performing means, for performing correlation processing upon the normalized feature vector, wherein the correlation processing includes:
(1) means for sorting the tested features;
(2) means, responsive to the sorting means, for organizing the sorted tested features into a correlation matrix; and
(3) means, responsive to the organizing means, for creating a correlation coefficient matrix corresponding and associated to the correlation matrix, wherein the correlation coefficient matrix includes information indicative of correlation between the tested features; and
(f) means, responsive to the correlation processing means, for removing a selected feature from a training set if the selected feature is determined to be highly correlated to one or more other features in the training set.

15. An automated vehicle safety system, comprising:
(a) an imaging device capable of obtaining images of a vehicle occupant;
(b) a computing device, operatively coupled to the imaging device, wherein the computing device is configured to select features of the images of the vehicle occupants in accordance with the feature selection method set forth in claim 1, and wherein the vehicle occupant is classified as one of a plurality of classifications based upon the features selected in accordance with the feature selection method; and
(c) an automated safety device, responsive to the computing device, wherein the safety device is selectively deployed based on the vehicle occupant classification as determined by the computing device.

16. An safety equipment deployment system in a vehicle having a vision-based peripheral capable of capturing images of a vehicle occupant and storing the images in a memory for subsequent processing by a digital signal processor (DSP), comprising:
(a) a DSP configured to synthesize a plurality of feature arrays based upon the occupant images and storing the feature arrays in the memory, wherein the DSP is further configured to implement the feature selection method set forth in claim 1, and wherein the DSP classifies the vehicle occupant into one of a plurality of occupant classifications based upon the features selected by the feature selection method; and
(b) a vehicle safety device, responsive to the DSP, wherein the safety device is selectively deployed based on the vehicle occupant classification as determined by the DSP.

17. The system of claim 16, wherein the DSP is further configured to compute at least one mathematical moment of a segmented image.

18. The system of claim 17, wherein the DSP is further configured to compute at least one edge image from the segmented image.

19. The system of claim 18, wherein the DSP is further adapted to convert the at least one edge image into a one dimensional vector representation by computing mathematical moments of the at least one edge image.

20. The system of claim 16, wherein the vehicle safety device comprises an airbag.
